(19) United States
(12) Patent Application Publication
(10) Pub. No.: US 2013/0179081 A1
(43) Pub. Date: Jul. 11, 2013

(54) System and Algorithm for Automatic Shale Picking and Determination of Shale Volume

(71) Applicants: Anne Bartetzko, Celle (DE); Stephan Dankers, Wunstorf (DE)

(72) Inventors: Anne Bartetzko, Celle (DE); Stephan Dankers, Wunstorf (DE)

(73) Assignee: Baker Hughes Incorporated, Houston, TX (US)

(21) Appl. No.: 13/347,883

(22) Filed: Jan. 11, 2012

(51) Int. Cl. G06F 19/00

(52) U.S. Cl. 702/8; 702/11

(57) ABSTRACT

The present disclosure relates to borehole logging methods and apparatuses for estimating a parameter of interest of an earth formation using logging data acquired in a borehole penetrating the earth formation. The method may include estimating the at least one parameter of interest using a statistical analysis of logging data acquired by at least one sensor, wherein the statistical analysis is applied over interval plurality of intervals within the logging data. The logging data may include one or more of: gamma ray data and spontaneous potential data. The method may include acquiring logging data with the at least one sensor. The method may also include estimating a confidence level for the at least one estimated parameter. The apparatus may include at least one sensor configured to generate logging data information about an earth formation; and at least one processor configured perform at least some of the steps of the method.

### FIELD OF THE DISCLOSURE

This disclosure generally relates to borehole logging methods and apparatuses for estimating formation properties using logging data of an earth formation.

### BACKGROUND OF THE DISCLOSURE

Studies of the earth formations indicate the regular occurrence of naturally radioactive elements in various proportions depending on the type of lithology. In the hydrocarbon industry, identifying the location of shale layers and knowing the proportion of shale in the formation is important, e.g. wellbore stability analysis, rock classification, computation of volumetric composition of the formation, including hydrocarbon saturation. Shale picking, i.e. identifying the location of shale layers is particularly important in pore pressure modeling as the most frequently used pore pressure prediction methods are based on the compaction behavior of shale.

A rigid or non-rigid carrier is often used to convey one or more nuclear radiation detectors, often as part of a tool or a set of tools, and the carrier may also provide communication channels for sending information up to the surface.

Several methods exist that allow identifying and quantifying shale from such measurements. The most frequently used approach is based on a gamma ray log. The gamma ray log provides a measure of the content of radioactive minerals in the formation. In sedimentary rocks, which are usually targeted in the hydrocarbon industry, radioactive elements are usually concentrated in clay minerals. Clay minerals are the most important constituent of shale.

The gamma ray log is not a quantitative measurement in the sense that it cannot directly be related to formation properties such as shale content. The number given by the log may depend on composition, depositional environment, and age of the rocks, but also the drilling environment if appropriate corrections have not been carried out.

### SUMMARY OF THE DISCLOSURE

In aspects, the present disclosure is related to methods and apparatuses for estimating a parameter of interest of an earth formation using statistical analysis of logging data, particularly for locating shale layers and estimating shale index/volume.

One embodiment according to the present disclosure includes of estimating at least one parameter of interest of an earth formation, comprising: estimating the at least one parameter of interest using a statistical analysis of logging data acquired by at least one sensor, wherein the statistical analysis is applied over a plurality of overlapping intervals within the logging data.

Another embodiment according to the present disclosure includes an apparatus for estimating at least one parameter of interest in an earth formation, comprising: a carrier configured to be conveyed in the borehole; at least sensor disposed on the carrier and configured to acquire logging data; and at least one processor configured to: estimate at least one parameter of interest using a statistical analysis of the logging data acquired by the at least one sensor, wherein the statistical analysis is applied over a plurality of overlapping intervals within the logging data.

Another embodiment according to the present disclosure includes a non-transitory computer-readable medium product having stored thereon instructions that, when executed by at least one processor, cause the at least one processor to perform a method, the method comprising: estimating the at least one parameter of interest using a statistical analysis of logging data acquired by at least one sensor, wherein the statistical analysis is applied over a plurality of overlapping intervals within the logging data.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a downhole tool deployed in a borehole along a drill string according to one embodiment of the present disclosure;

FIG. 2 shows a schematic of a detection module for one embodiment according to the present disclosure;

FIG. 3 shows a flow chart for a method for one embodiment according to the present disclosure;

FIG. 4(a) shows a flow chart expanding on locating a shale layer for the method of FIG. 3 for one embodiment according to the present disclosure;

FIG. 4(b) shows a flow chart expanding on estimating a shale percentage for the method of FIG. 3 for one embodiment according to the present disclosure;

FIG. 5 shows a schematic of an apparatus for implementing one embodiment of the method according to the present disclosure.

FIG. 6(a) shows a chart with an indexed histogram of naturally emitted gamma rays for one embodiment according to the present disclosure;

FIG. 6(b) shows a chart with a cumulative curve of naturally emitted gamma rays from FIG. 6(a) for one embodiment according to the present disclosure;

FIG. 7 shows a chart of logging data with 3 splits for one embodiment according to the present disclosure;

FIG. 8 shows a chart of logging data with 3 splits, shale qualification, and confidence level for one embodiment according to the present disclosure;

FIG. 9 shows a chart for evaluating shale/sand for a single depth for one embodiment according to the present disclosure;

FIG. 10 shows another chart for evaluating shale/sand for a single depth for one embodiment according to the present disclosure;

FIG. 11(a) shows a chart with ⅚ overlap between intervals for one embodiment according to the present disclosure;

FIG. 11(b) shows a chart with ⅔ overlap between intervals for one embodiment according to the present disclosure;

FIG. 12 shows a chart with shale and sand lines for overlapping intervals for one embodiment according to the present disclosure;

FIG. 13 shows a chart shale and sand lines selected for a shale volume analysis for one embodiment according to the present disclosure;

FIG. 14 shows a chart of a real-time application using the lowest sand line for one embodiment according to the present disclosure;

FIG. 15 shows a chart with top-down intervals for one embodiment according to the present disclosure;

FIG. 16 shows a chart with bottom-up intervals for one embodiment according to the present disclosure; and

FIG. 17 shows a chart with bottom-up intervals and a single depth point number for one embodiment according to the present disclosure.

### DETAILED DESCRIPTION

In aspects, the present disclosure is related to methods and apparatuses for estimating a parameter of interest of an earth formation using statistical analysis of logging data, particularly for locating shale layers and estimating shale index/volume.

A well log, such as, but not limited to, a gamma ray log or a spontaneous potential log, may be used for shale picking and shale volume determination. For example, if using a gamma ray log, then, in order to identify shale layers, a cut-off line may be selected from the gamma ray log, and all depth intervals with gamma ray values higher (or equal and higher) than the cut-off value may be identified as shale. In the case of wellbore stability modeling, multiple shale cut-off lines may be selected to account for variations in the gamma ray log with depth.

For estimating shale volume, two or more lines may be used. A sand line (also called sand-base line or clean line) distinguishes the non-shale (clean) formation from shale containing formations. Depth intervals with gamma ray values lower than the sand threshold line may be considered to be free of shale. The sand line may represent 0% shale. The second line (shale line or shale base line) may represent 100% shale, and the depth intervals with gamma ray values higher (or equal and higher) than the shale line may be considered to represent shale. For the depth intervals with intermediate gamma ray values, a shale index, Iₛₕ, may be calculated using Eqn. 1, which can be found in most textbooks on well log interpretation (e.g. Rider and Kennedy, 2011):

$${I}_{sh} = \frac{{GR}_{value ( log )} - {GR}_{( min )}}{{GR}_{( max )} - {GR}_{( min )}} \qquad ( 1 )$$

In some embodiments, a linear relationship between gamma ray and shale volume may be assumed and the shale index can directly be used to calculate shale volume Vₛₕ. Otherwise, correction factors may be used to convert the shale index into shale volume in case of non-linear relationships.

Simple statistics may be used to suggest sand and shale lines over short depth intervals. In these cases, constant thresholds may be applied for the entire data set and/or histograms may be used over sliding windows to determine threshold values for sand and shale.

While the simple statistical approaches may provide reasonable results when applied over short depth intervals, these approaches may not be effective in cases where there are significant changes in gamma ray response such as due to (i) variations in composition of the shale, depositional environment, compaction (age) and (ii) drilling environment (changes in hole size, mud system, applied environmental corrections). Additionally, some simple statistical approaches may be limited for real-time applications because the entirety of the data set is not known.

These problems may be overcome using an approach based on a frequency analysis that is carried out over overlapping depth intervals of defined and limited length. For each single depth interval, a simple statistical calculation may be carried out. The approach allows for both (i) definition of shale layers (mode 1) and (ii) determination of sand and shale lines for shale index/volume calculation (mode 2). Determining a shale index/volume may include estimating a shale percentage or shale fraction. In some embodiments, an algorithm may be used that can process both modes simultaneously. The use of depth intervals of limited length may be particularly useful in real-time applications as it allows for reaction to changes in the gamma ray log.

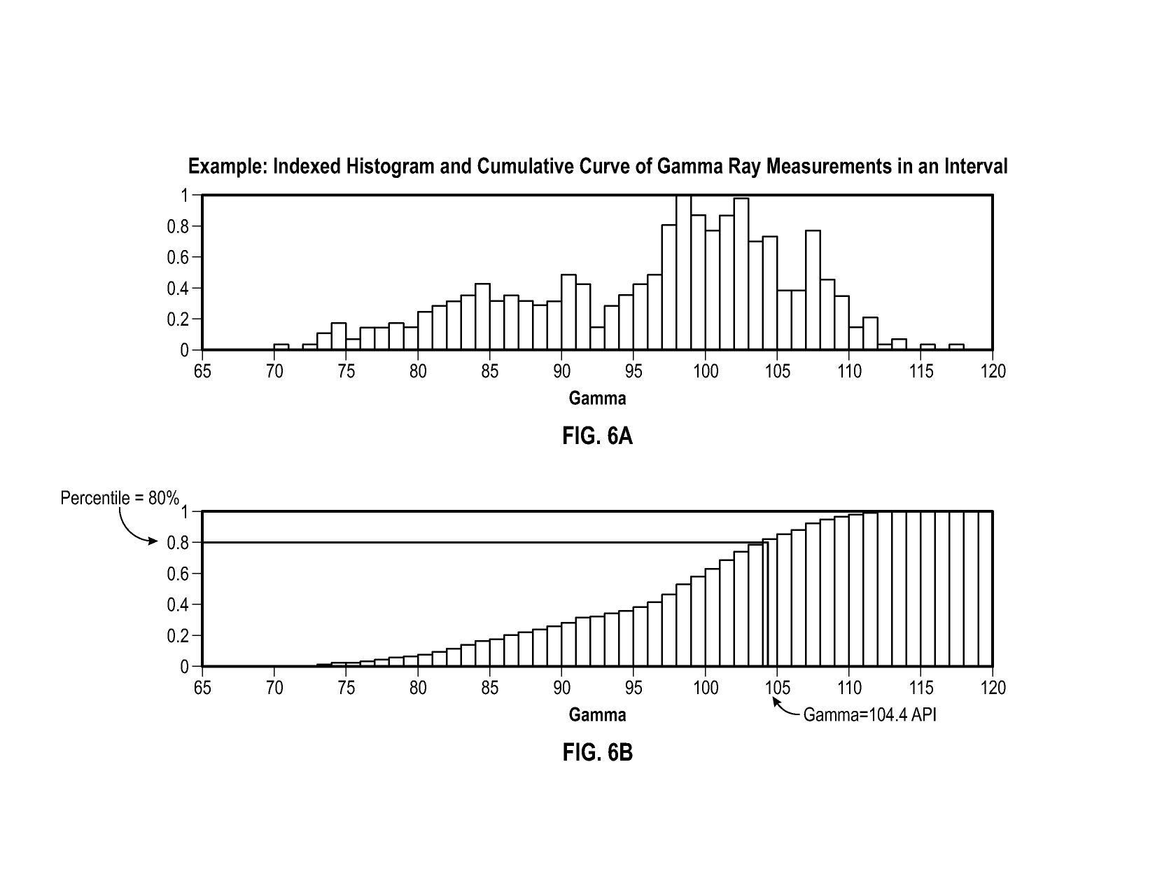

For each depth interval, a percentile at a predefined or automatically set value may be determined. For example, FIG. 6(a) shows an indexed histogram of gamma ray measurements in an interval. FIG. 6(b) shows a cumulative curve of the gamma ray measurements with percentile set to 80%. A typical value for shale picking could be, for example, to select the 80th percentile. The gamma ray value at this percentile value may be used as a shale cut-off value. For each depth point in the interval, the gamma ray value may be compared with the shale cut-off value. If the gamma ray value is greater (or greater and equal) than the shale cut-off value, the depth point may be classified as shale and flagged accordingly (e.g. flag 1). Otherwise the depth point may be classified as non-shale (e.g. flag 0). The entire data set may be continuously reprocessed once new data is streaming into the system until the results achieve the desired level of stability or are marked as definite results.

For shale index/volume calculation, two lines, a sand line and a shale line may be required. For the shale line, processing may be identical with the processing of the shale cut-off lines as described above, only that a different value for percentile value (e.g. 90%) may be used.

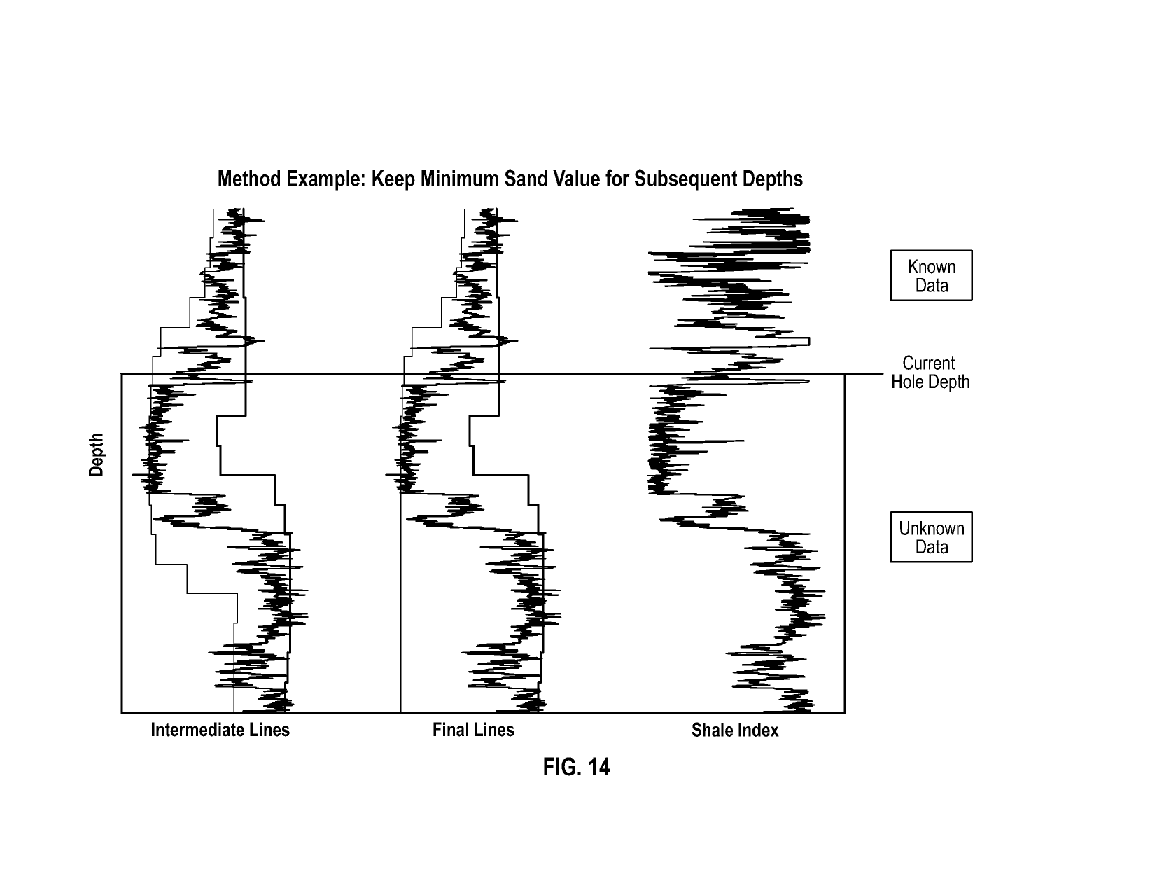

For the sand line, processing may also be identical as described for the shale cut-off lines as described above. In this case, a lower percentile (e.g. 5%) may be used. However, in thick shale layers, the 5% percentile may still give a sand line that is too high and, consequently, the sand volume calculated will be too high. To prevent or to reduce this effect, the algorithm offers the options of one or more of: (i) keeping the lowest sand line value found in the entire analysis (See FIG. 14), (ii) using a start value may be given for the sand line, which will only be modified if a percentile value lower than the start value is found, and (iii) continuously reprocessing the entire data set once new data is streaming into the system until the results are stable, approaching stability, or marked as definite results.

The processing of the data set may include the use of overlapping intervals. This allows processing multiple analyses at one depth point based on a different subset of gamma ray values. As a result, multiple results are available for a particular depth point, which also allows the assignment of one or more quality or confidence levels to the results.

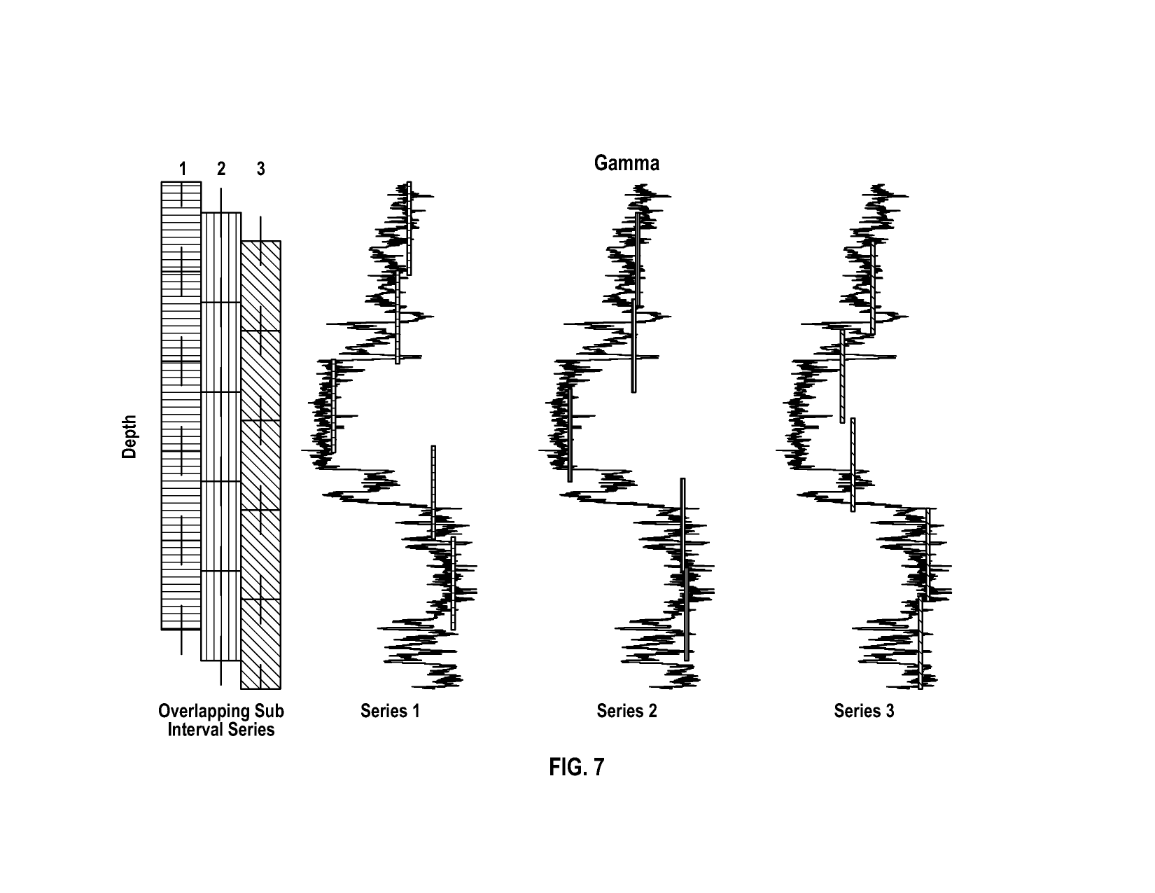

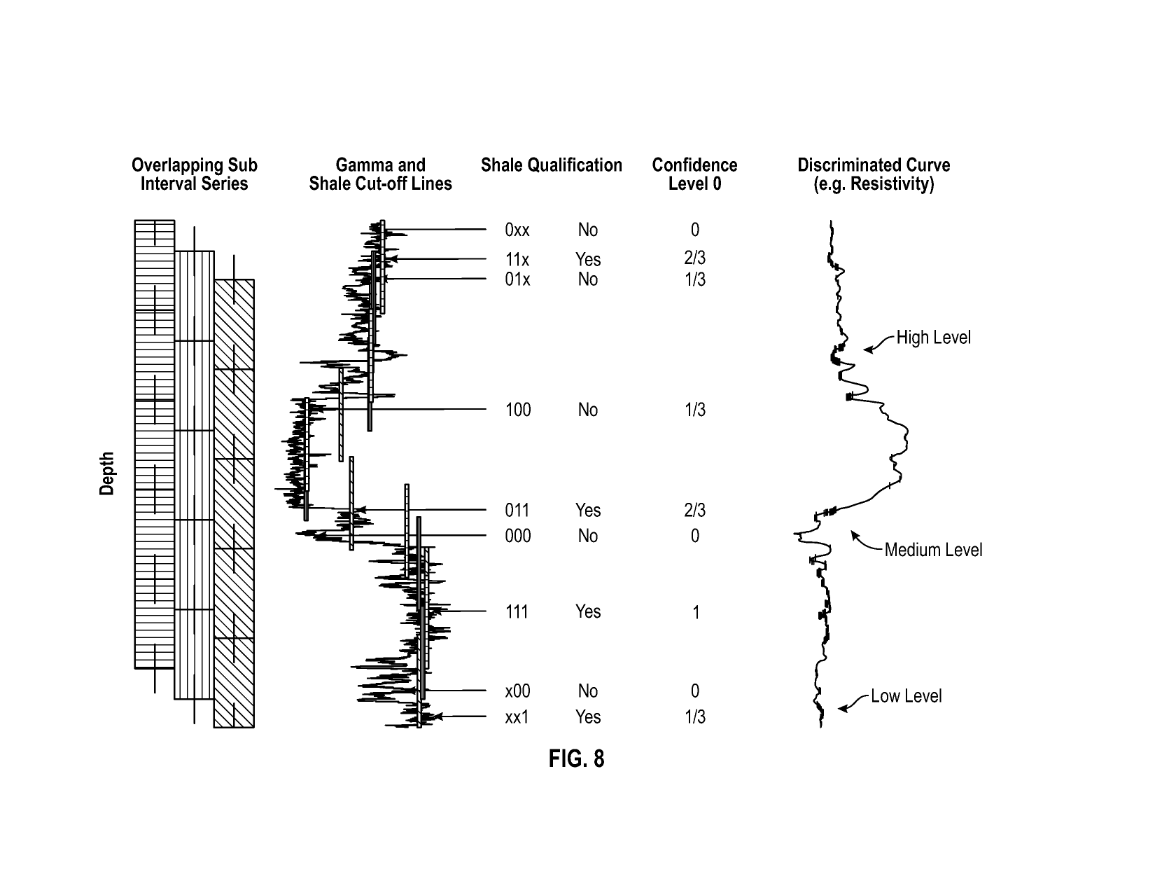

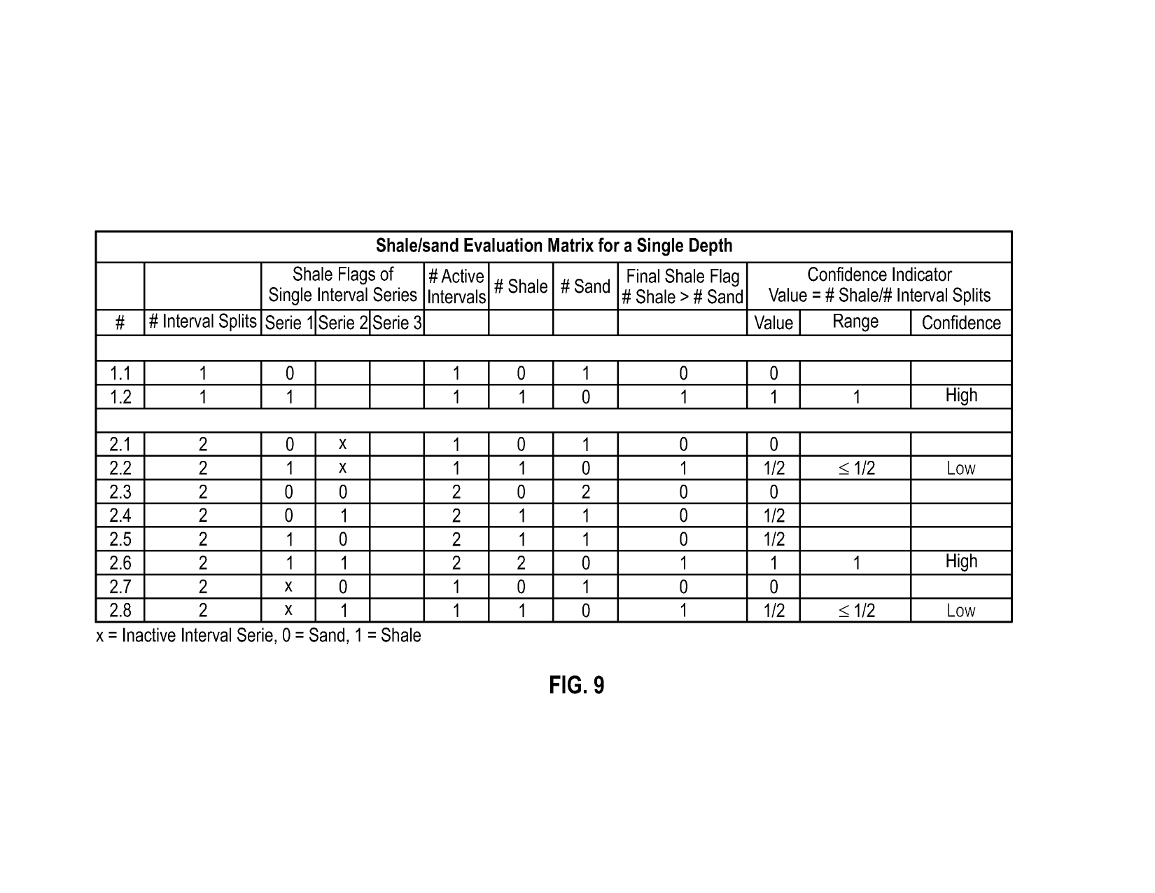

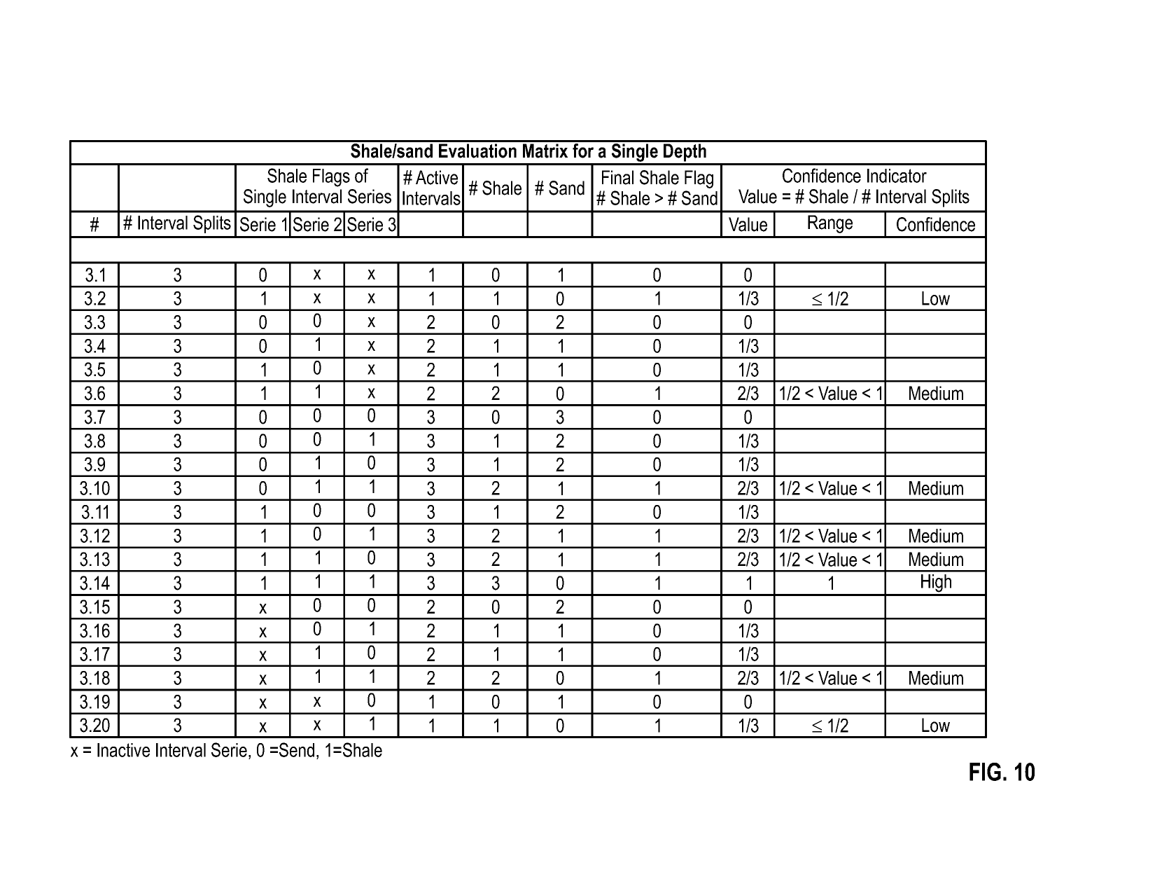

In principle, the algorithms may be used with any number of overlaps/splits, including no overlap (one split). For simplification, FIGS. 7 and 8 show examples with three splits. FIGS. 9 and 10 show examples of an evaluation matrix for up to three splits.

The length of the intervals may be predefined or determined while the algorithm is processing the data. Typically, local geological conditions, i.e. expected length of non-shale intervals may be used in determining the length of the interval. The length of the intervals may be defined in units of length (e.g. m or ft) or number data (i.e. number of depth points). The lengths of the depth intervals may be identical or may differ one from another. In some cases, local geological conditions may require varying the length of the intervals.

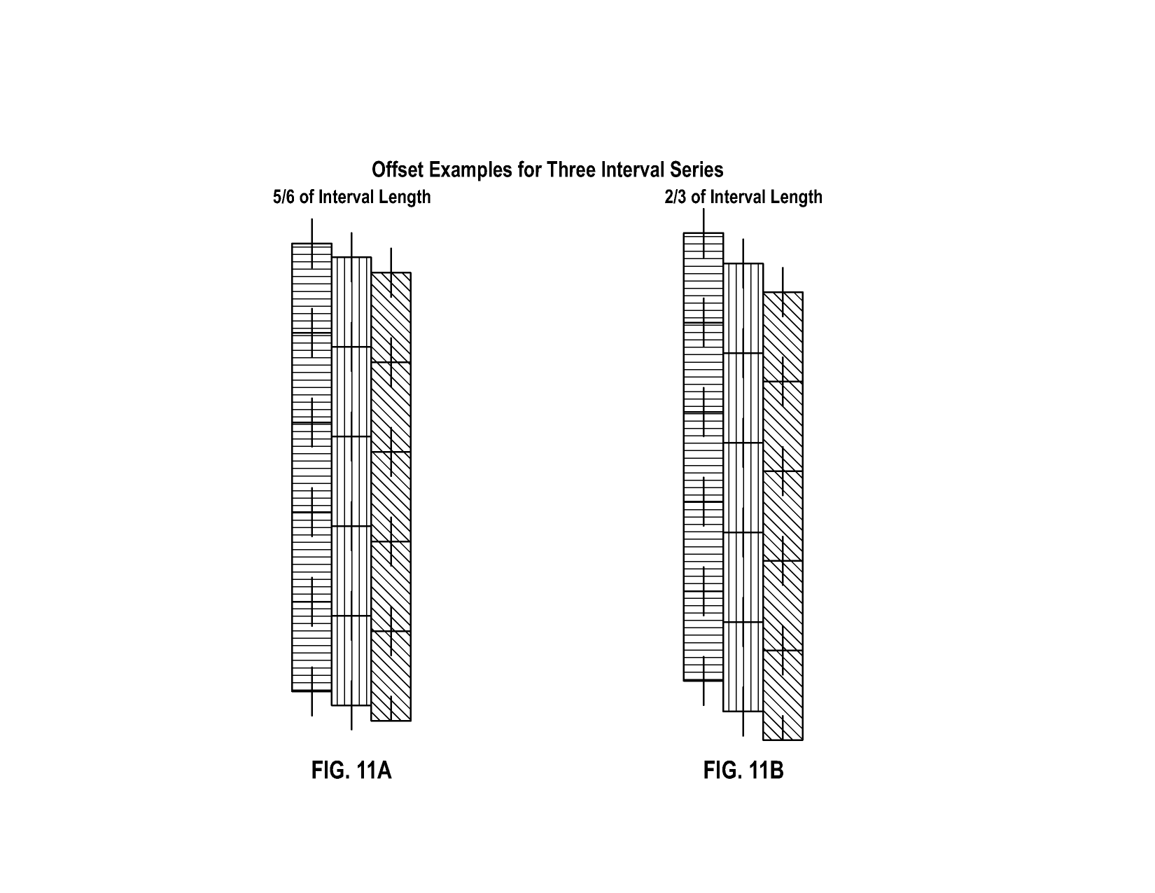

In some embodiments, the lengths of the overlapping sections may be derived from the number of splits and the interval length (e.g. 2 splits=50% of interval length, 3 splits=66⅔%). Alternatively it can be predefined or automatically adjusted with any number between more than 0% and less than 100% FIG. 11(a) shows an example of 3 splits with an overlap of 83⅓%. FIG. 11(b) shows an example of 3 splits with an overlap of 66⅔%.

For shale picking, as shown in FIGS. 7 to 10, an individual shale flag may be set for each depth point and for each single interval. If the number of set shale flags is greater than the number of unset shale flags for a depth point, the final shale flag may be set to 1. Otherwise it may be set to 0. Depending on the way the overlapping intervals are defined, the number of active intervals may be fewer than the number of splits. This may be the case at the start and the end of the entire data set. The shale classification value may be estimated as follows:

$$Shale classification value = \frac{number of classifications as shale}{number of active intervals} \qquad ( 2 )$$

FIGS. 9 and 10 show examples for up to 3 splits with any possible combination of active intervals and individual interval shale classifications.

The shale confidence level may be estimated as follows:

$$Shale confidence level = \frac{number of classifications as shale}{number of splits} \qquad ( 3 )$$

The confidence levels may be grouped into low, medium and high levels as illustrated below.

| | |
|---|---|
| Low | 0 ≦ Shale confidence level ≦ 0.5 |
| Medium | 0.5 < Shale confidence level < 1 |
| High | Shale confidence level = 1 |

The designation of the ranges for the shale confidence levels are exemplary and illustrative only, as other ranges may be used. The number of confidence levels may be a function of the number of splits.

In case of more splits or other applications of the algorithms, decision rules, shale flag index calculations and confidence level assignment rules may be modified. Additionally the number of splits can also be considered in the confidence level (e.g. more splits=higher confidence level).

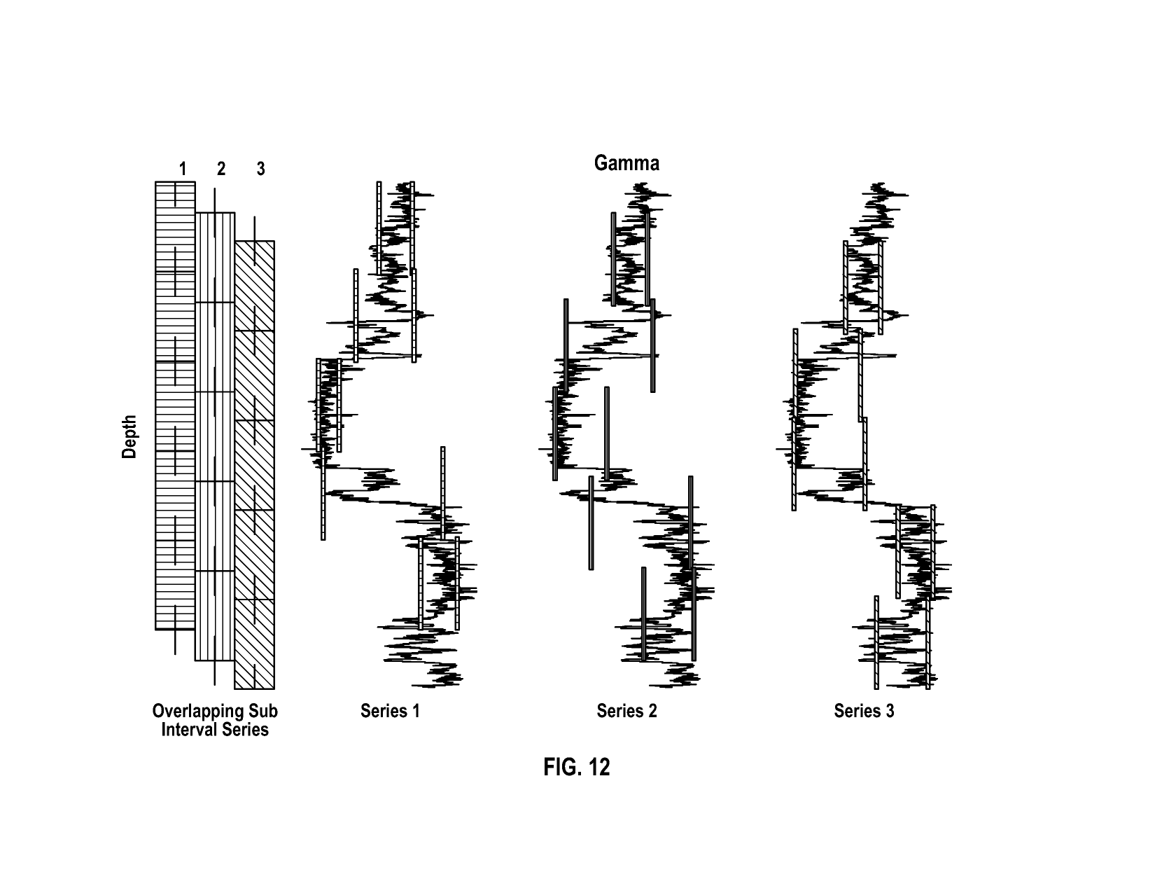

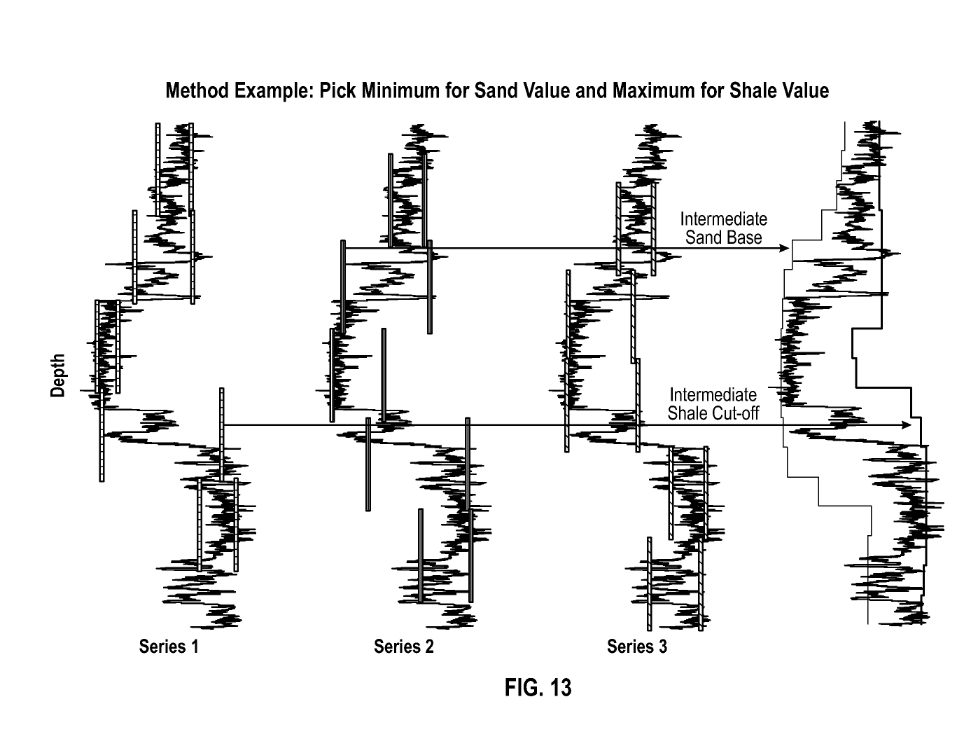

The use of overlapping intervals may lead to multiple sand and shale lines for each depth point, as shown in FIG. 12. For a typical shale volume analysis, a minimum line may be used for the sand line and a maximum line for the shale line as shown in FIG. 13. However, depending on the purpose of the analysis, either the minimum, middle, maximum line or an average line may be used for the sand and shale lines as necessary.

FIG. 14 shows an example of a real-time application where the option of keeping the lowest sand line encountered is applied. While sand volume is too high in the upper third of the displayed interval, more realistic sand and shale volumes may be found for the lower two thirds of the data set.

When using depth intervals of pre-defined length, it is possible that intervals may not be full, e.g. at the end of the data set when the pre-defined interval length is 200 ft, the remaining data set may only be 110 ft long. Moreover, in real-time applications, when data are streaming in, it may take a while until sufficient data is received to obtain a full interval. This incomplete depth interval may be addressed by: (i) having the algorithm apply the usual process on the data but provide an indication that the quality may not be sufficient as the amount of data is reduced or (ii) processing only full intervals.

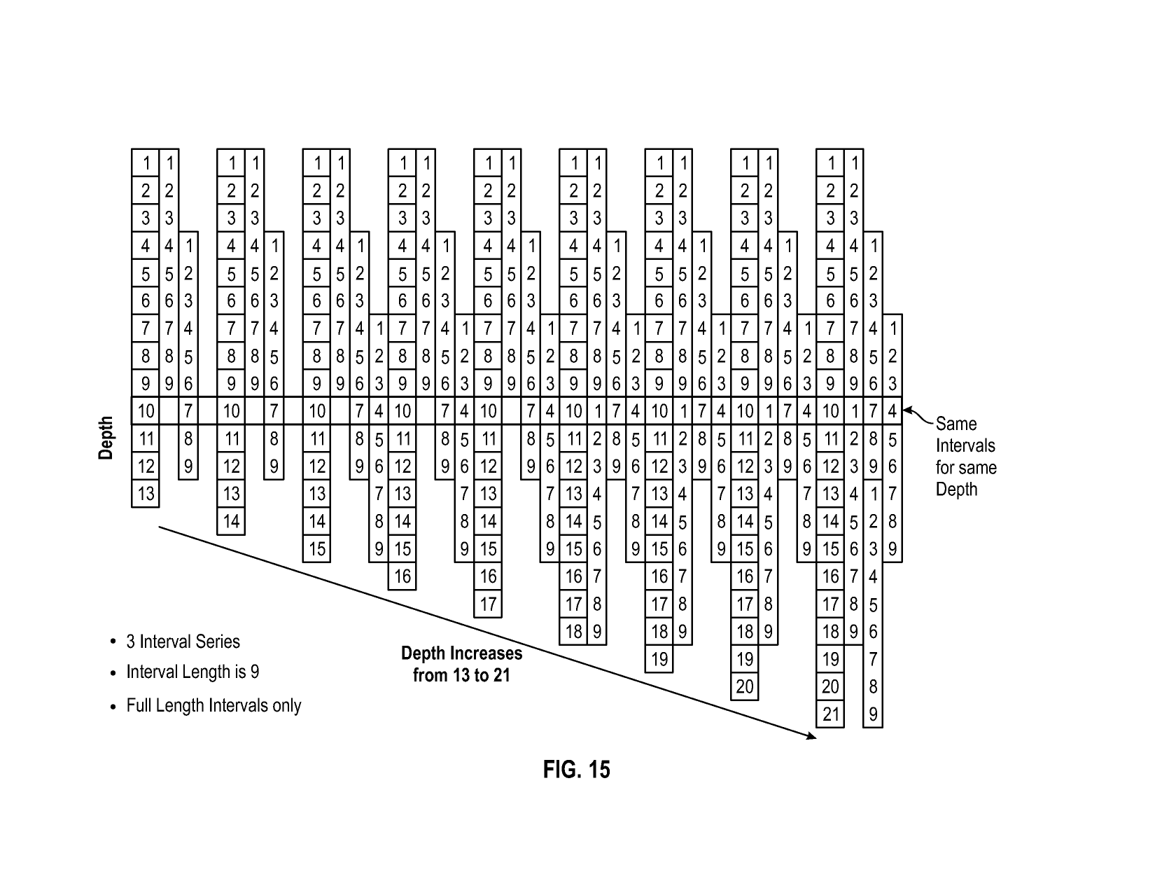

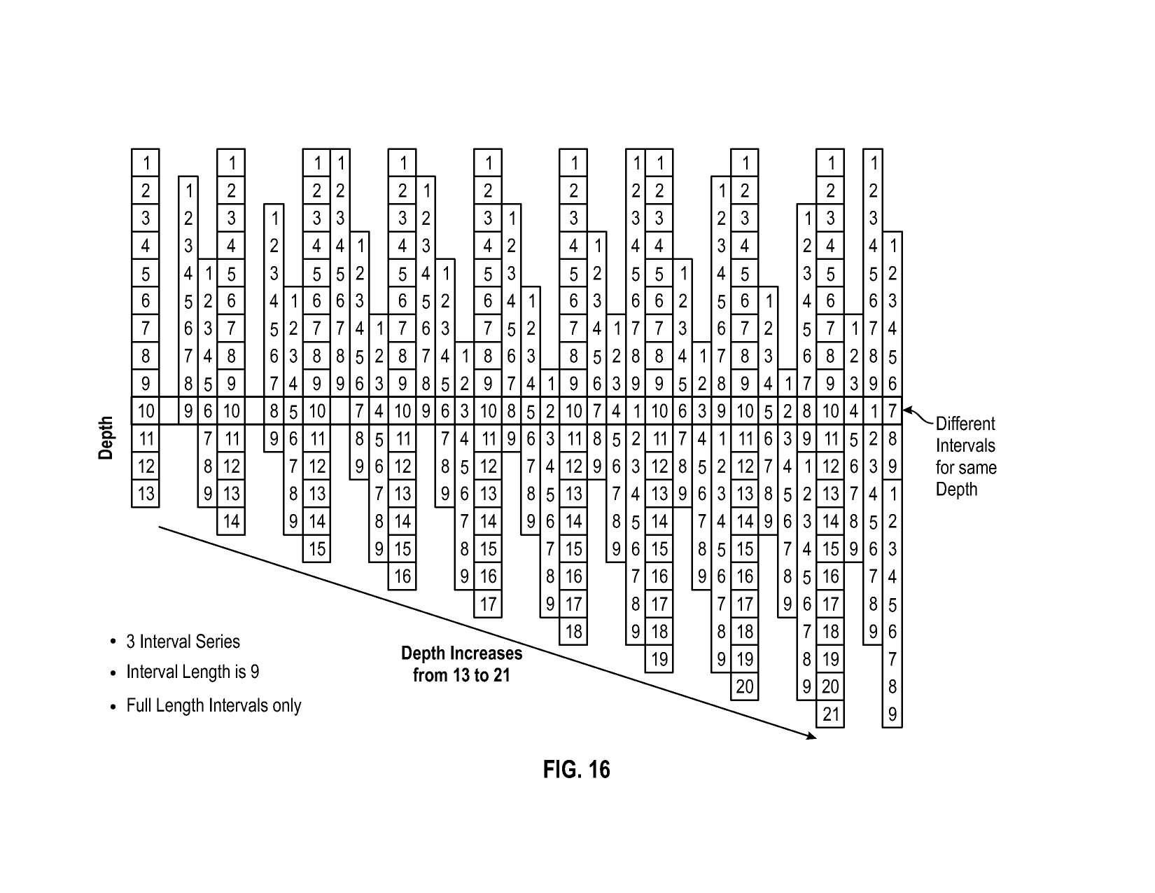

In real-time applications when data is streaming in, another possibility is to start processing with a reduced amount of data and to reprocess the depth intervals once they reached the complete length or amount of data. The intervals may be defined as top-down or bottom-up. When using top-down intervals, as shown in FIG. 15, the filling of the intervals starts at the beginning of the data set or a predefined or automatically set start depth and depth intervals are filled up to bottom until they reach their full length. When using bottom-up intervals, as shown in FIG. 16, the filling of the intervals starts at the end of the data set and the intervals are filled up until the intervals reach the full length.

The difference between the multiple sand and shale lines may be used to determine a confidence level or uncertainty. Depth intervals with large differences between the different sand lines and the different shale lines may show strong variations in the gamma ray log with depth, and, therefore, the confidence level may be lower than for a homogeneous interval with smaller differences between the lines.

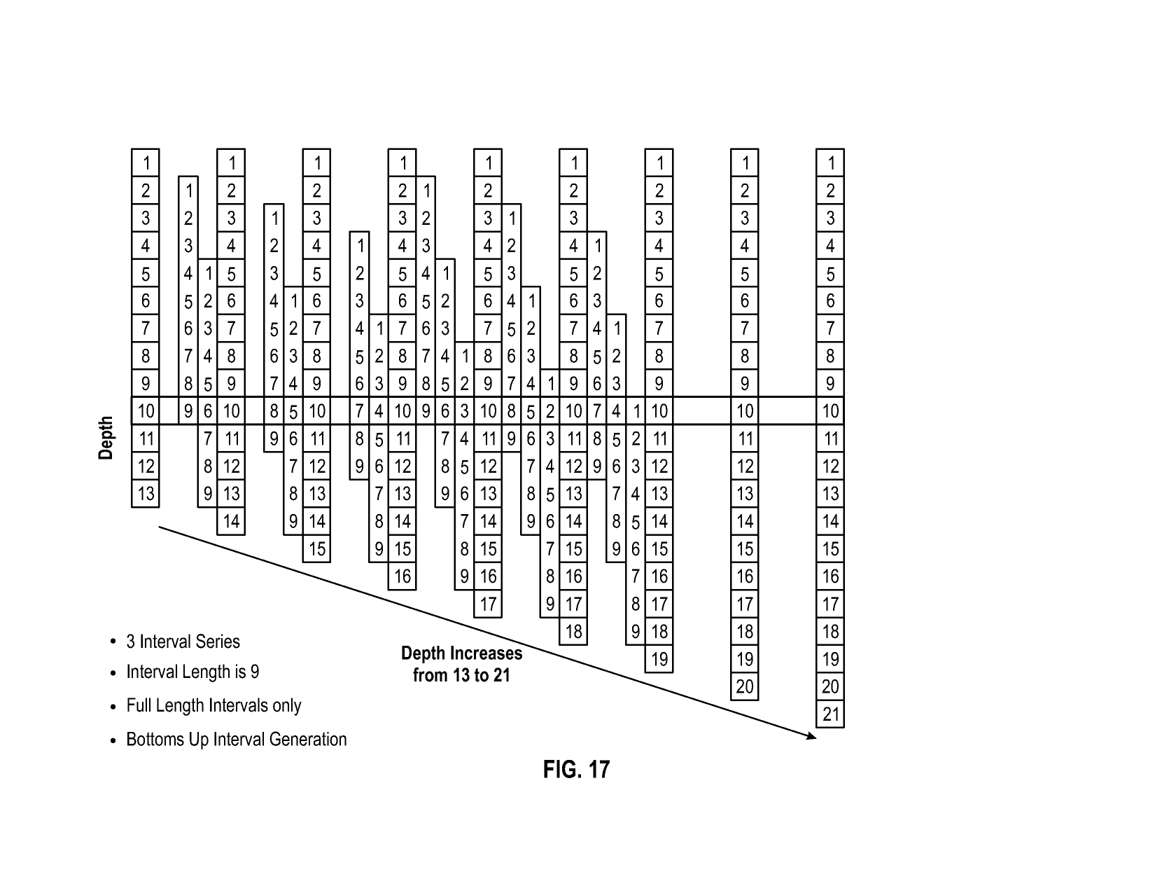

FIG. 17 shows an example for a single depth point number 10, 3 splits and interval length 9 if the intervals are fully filled from bottom to top. In this example with an equidistant depth distance of 1 the results for this depth may be calculated 6 times and measurements from depth point number 2 down to depth point number 18 are considered. Looking along the time line from left to right the result can first be (re-)calculated three times with two active intervals and then three times with three active intervals. These multiple calculation options may be used to increase the confidence level of the results.

A description for some embodiments estimating the at least one parameter of interest follows below.

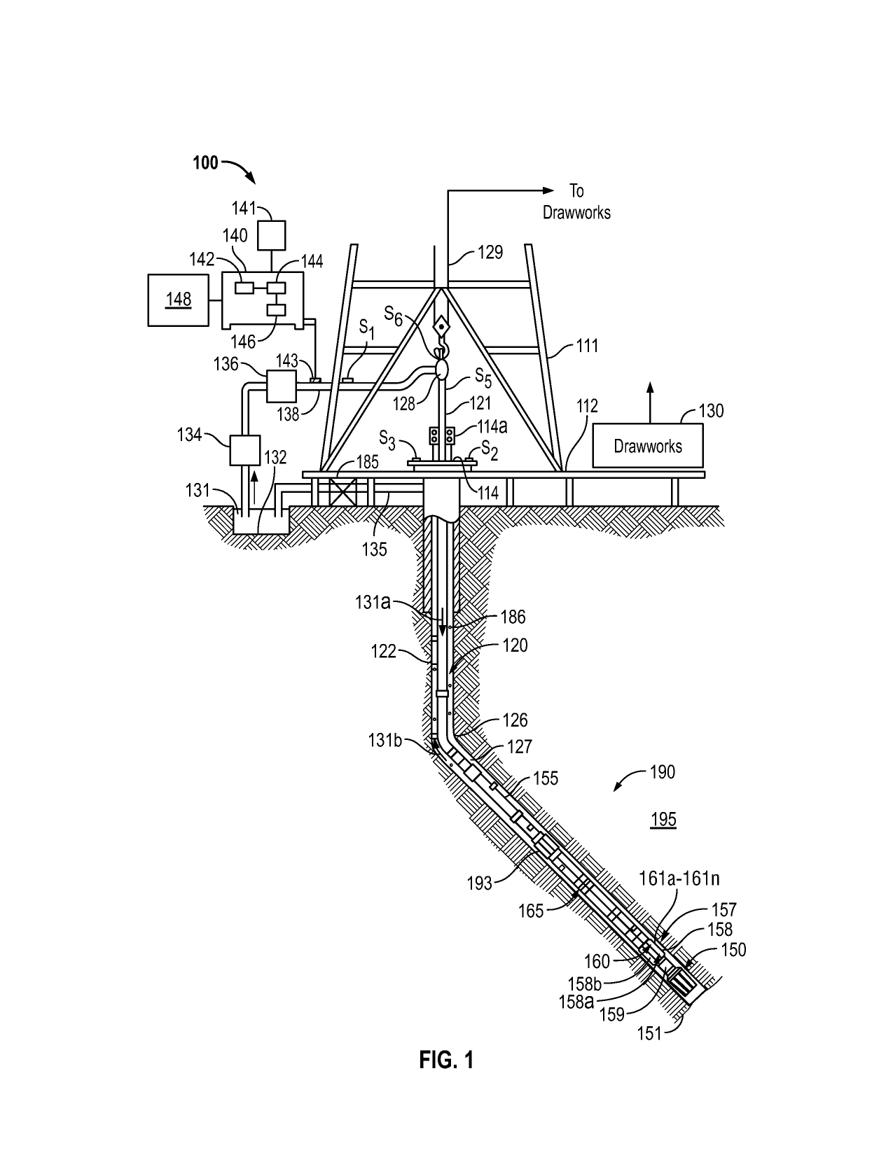

FIG. 1 shows a schematic diagram of an exemplary drilling system 100 with a drill string 120 that includes a drilling assembly or bottom hole assembly (BHA) 190 conveyed in a borehole 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe) 122, having the drilling assembly 190, attached at its bottom end extends from the surface to the bottom 151 of the borehole 126. A drill bit 150, attached to drilling assembly 190, disintegrates the geological formations when it is rotated to drill the borehole 126. The drill string 120 is coupled to a draw works 130 via a Kelly joint 121, swivel 128 and line 129 through a pulley. Drawworks 130 is operated to control the weight on bit (“WOB”). The drill string 120 may be rotated by a top drive (not shown) instead of by the prime mover and the rotary table 114. Alternatively, a coiled-tubing may be used as the tubing 122. A tubing injector 114a may be used to convey the coiled-tubing having the drilling assembly attached to its bottom end. The operations of the drawworks 130 and the tubing injector 114a are known in the art and are thus not described in detail herein.

A suitable drilling fluid 131 (also referred to as the “mud”) from a source 132 thereof, such as a mud pit, is circulated under pressure through the drill string 120 by a mud pump 134. The drilling fluid 131 passes from the mud pump 134 into the drill string 120 via a desurger 136 and the fluid line 138. The drilling fluid 131a from the drilling tubular discharges at the borehole bottom 151 through openings in the drill bit 150. The returning drilling fluid 131b circulates uphole through the annular space 127 between the drill string 120 and the borehole 126 and returns to the mud pit 132 via a return line 135 and drill cutting screen 185 that removes the drill cuttings 186 from the returning drilling fluid 131b. A sensor S₁ in line 138 provides information about the fluid flow rate. A surface torque sensor S₂ and a sensor S₃ associated with the drill string 120 respectively provide information about the torque and the rotational speed of the drill string 120. Tubing injection speed is determined from the sensor S₅, while the sensor S₆ provides the hook load of the drill string 120.

In some applications, the drill bit 150 is rotated by only rotating the drill pipe 122. However, in many other applications, a downhole motor 155 (mud motor) disposed in the drilling assembly 190 also rotates the drill bit 150. The rate of penetration (ROP) for a given BHA largely depends on the WOB or the thrust force on the drill bit 150 and its rotational speed.

The mud motor 155 is coupled to the drill bit 150 via a drive shaft disposed in a bearing assembly 157. The mud motor 155 rotates the drill bit 150 when the drilling fluid 131 passes through the mud motor 155 under pressure. The bearing assembly 157, in one aspect, supports the radial and axial forces of the drill bit 150, the down-thrust of the mud motor 155 and the reactive upward loading from the applied weight-on-bit.

A surface control unit or controller 140 receives signals from the downhole sensors and devices via a sensor 143 placed in the fluid line 138 and signals from sensors S₁-S₆ and other sensors used in the system 100 and processes such signals according to programmed instructions provided to the surface control unit 140. The surface control unit 140 displays desired drilling parameters and other information on a display/monitor 141 that is utilized by an operator to control the drilling operations. The surface control unit 140 may be a computer-based unit that may include a processor 142 (such as a microprocessor), a storage device 144, such as a solid-state memory, tape or hard disc, and one or more computer programs 146 in the storage device 144 that are accessible to the processor 142 for executing instructions contained in such programs. The surface control unit 140 may further communicate with a remote control unit 148. The surface control unit 140 may process data relating to the drilling operations, data from the sensors and devices on the surface, data received from downhole, and may control one or more operations of the downhole and surface devices. The data may be transmitted in analog or digital form.

The BHA 190 may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the formation 195 surrounding the BHA 190. Such sensors are generally known in the art and for convenience are generally denoted herein by numeral 165. The BHA 190 may further include a variety of other sensors and devices 159 for determining one or more properties of the BHA 190 (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 159.

The BHA 190 may include a steering apparatus or tool 158 for steering the drill bit 150 along a desired drilling path. In one aspect, the steering apparatus may include a steering unit 160, having a number of force application members 161a-161n, wherein the steering unit is at partially integrated into the drilling motor. In another embodiment the steering apparatus may include a steering unit 158 having a bent sub and a first steering device 158a to orient the bent sub in the wellbore and the second steering device 158b to maintain the bent sub along a selected drilling direction.

The drilling system 100 may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED. Suitable systems are also discussed in “Downhole Diagnosis of Drilling Dynamics Data Provides New Level Drilling Process Control to Driller”, SPE 49206, by G. Heisig and J. D. Macpherson, 1998.

The drilling system 100 can include one or more downhole processors at a suitable location such as 193 on the BHA 190. The processor(s) can be a microprocessor that uses a computer program implemented on a suitable machine readable medium that enables the processor to perform the control and processing. The machine readable medium may include ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, the MWD system utilizes mud pulse telemetry to communicate data from a downhole location to the surface while drilling operations take place. The use of mud pulse telemetry is exemplary and illustrative only, as other information transfer techniques known to those of skill in the art may be used, including, but not limited to, electronic signals through wired pipe. The surface processor 142 can process the surface measured data, along with the data transmitted from the downhole processor, to evaluate formation lithology. While a drill string 120 is shown as a conveyance system for sensors 165, it should be understood that embodiments of the present disclosure may be used in connection with tools conveyed via rigid (e.g. jointed tubular or coiled tubing) as well as non-rigid (e.g. wireline, slickline, e-line, etc.) conveyance systems. The drilling system 100 may include a bottomhole assembly and/or sensors and equipment for implementation of embodiments of the present disclosure on either a drill string or a wireline. A point of novelty of the system illustrated in FIG. 1 is that the surface processor 142 and/or the downhole processor 193 are configured to perform certain methods (discussed below) that are not in prior art.

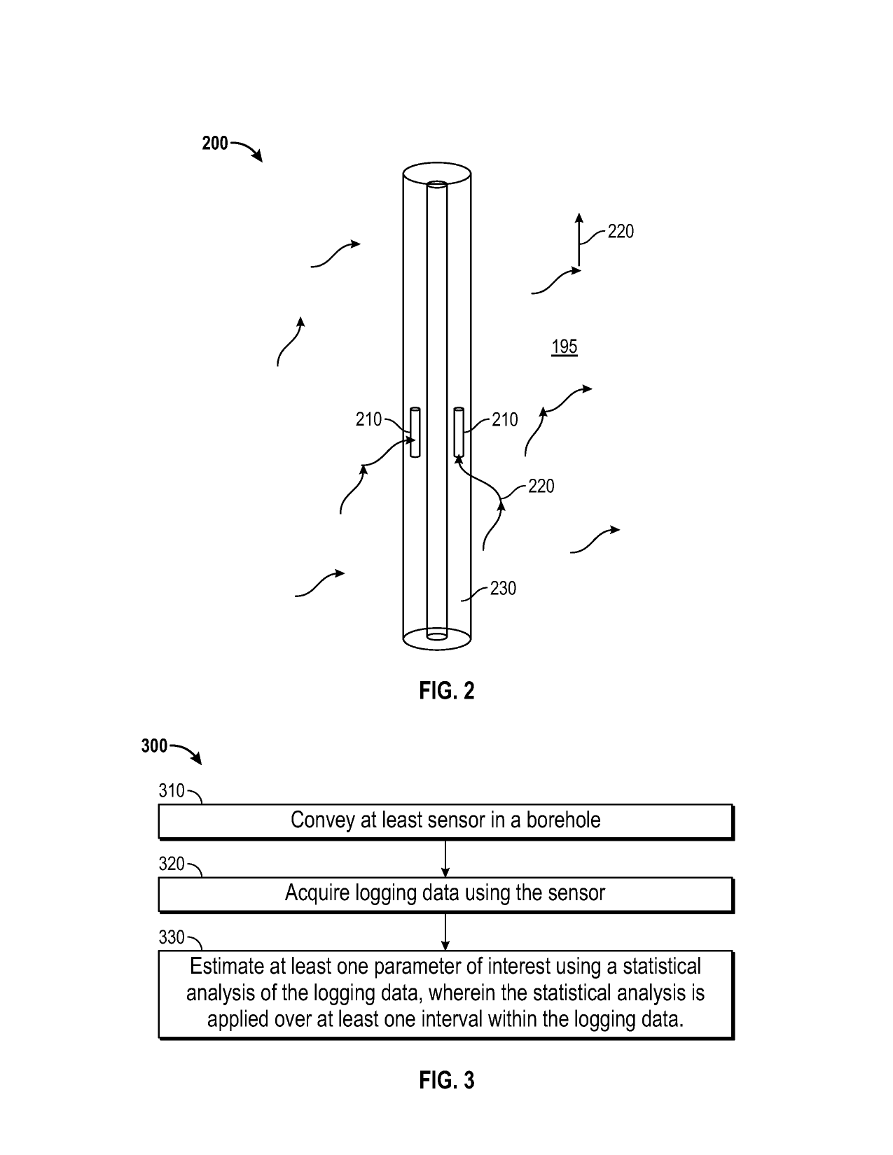

FIG. 2 shows an exemplary detection module 200 that may be incorporated in BHA 190, such as along with evaluation sensors 165 according to one embodiment of the present disclosure. The detection module 200 may include one or more sensors 210 configured to acquire logging data about the earth formation 195. The logging data may include, but is not limited to, nuclear radiation emissions and spontaneous electrical potentials. In FIG. 2, nuclear radiation emissions 220 may be the result of gamma rays emitted by or scattering by earth formation 195. The depiction of the detection module 200 having two radiation detectors 210 azimuthally separated at the same drilling depth is exemplary and illustrative only, as any number of radiation detectors may be used at one or more drilling depths on one or multiple sides of the detection module 200. In some embodiments, one or more electrodes (not shown) may be disposed on the BHA 190 and configured to detect electrical potentials in the earth formation 195 induced by a surface electrode (not shown).

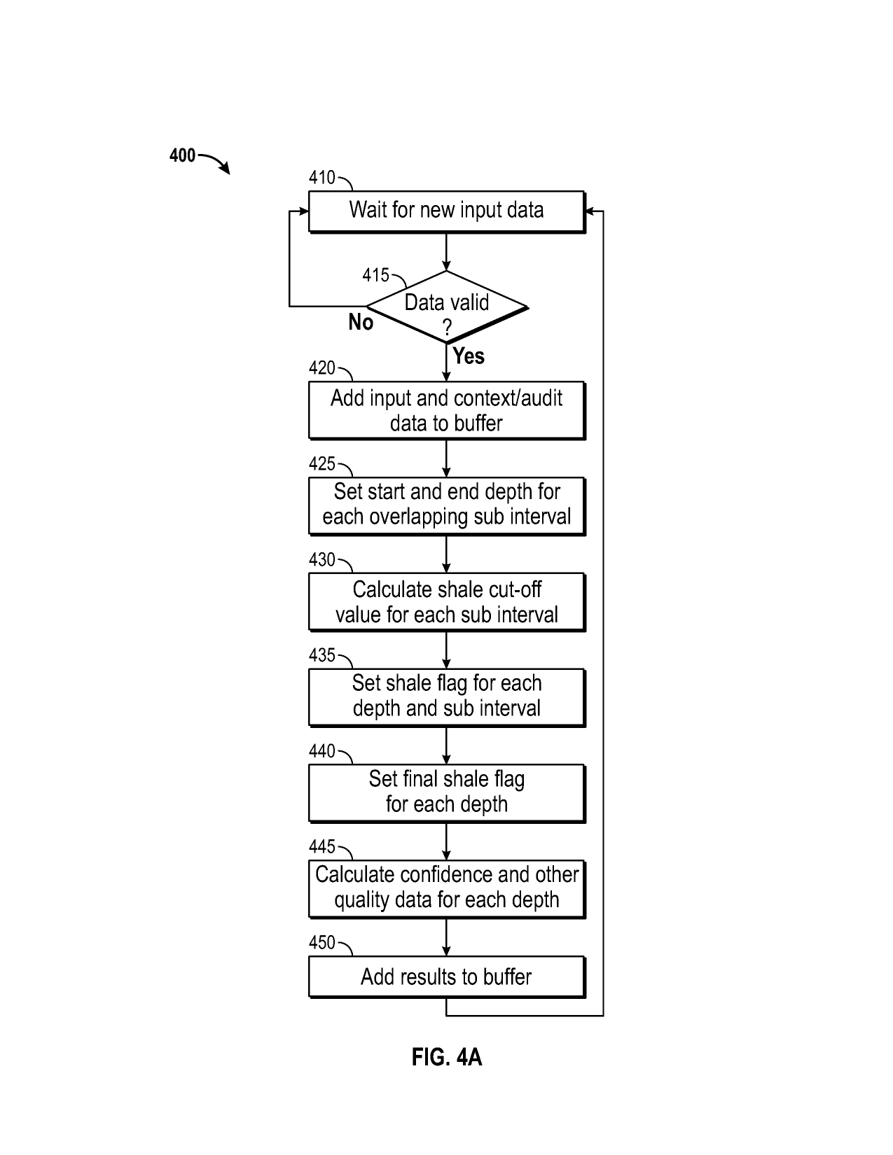

FIG. 3 shows a flow chart 300 for estimating a parameter of interest of the earth formation 195 according to one embodiment of the present disclosure. In step 310, at least one radiation detector 210 may be conveyed into a borehole 126 penetrating the earth formation 195. The at least one radiation detector 210 may be configured to generate a signal in response to gamma radiation. In step 320, the at least one radiation detector 210 may acquire logging data using the sensor. The logging data may use a signal generated by the sensor, the signal being indicative of gamma rays emitted by the earth formation 195. In step 330, the at least one parameter of interest may be estimated using a statistical analysis of the logging data. The statistical analysis may be applied over at least one interval within the logging data. The at least one parameter of interest may include one or more of: (i) a location of a shale layer and (ii) a shale percentage. In some embodiments, step 330 may be performed in real-time.

The at least one interval in step 330 may include a plurality of overlapping intervals. The plurality of overlapping intervals may have lengths that are identical or different. Each of the overlapping intervals may have a region that does not overlap with at least one other of the overlapping intervals. The estimation of a shale layer location in step 330 may include using a count of intervals in the at least one interval and a count of shale classifications in the at least one interval. The estimation of a shale percentage in step 330 may include using an estimated sand line and an estimated shale line.

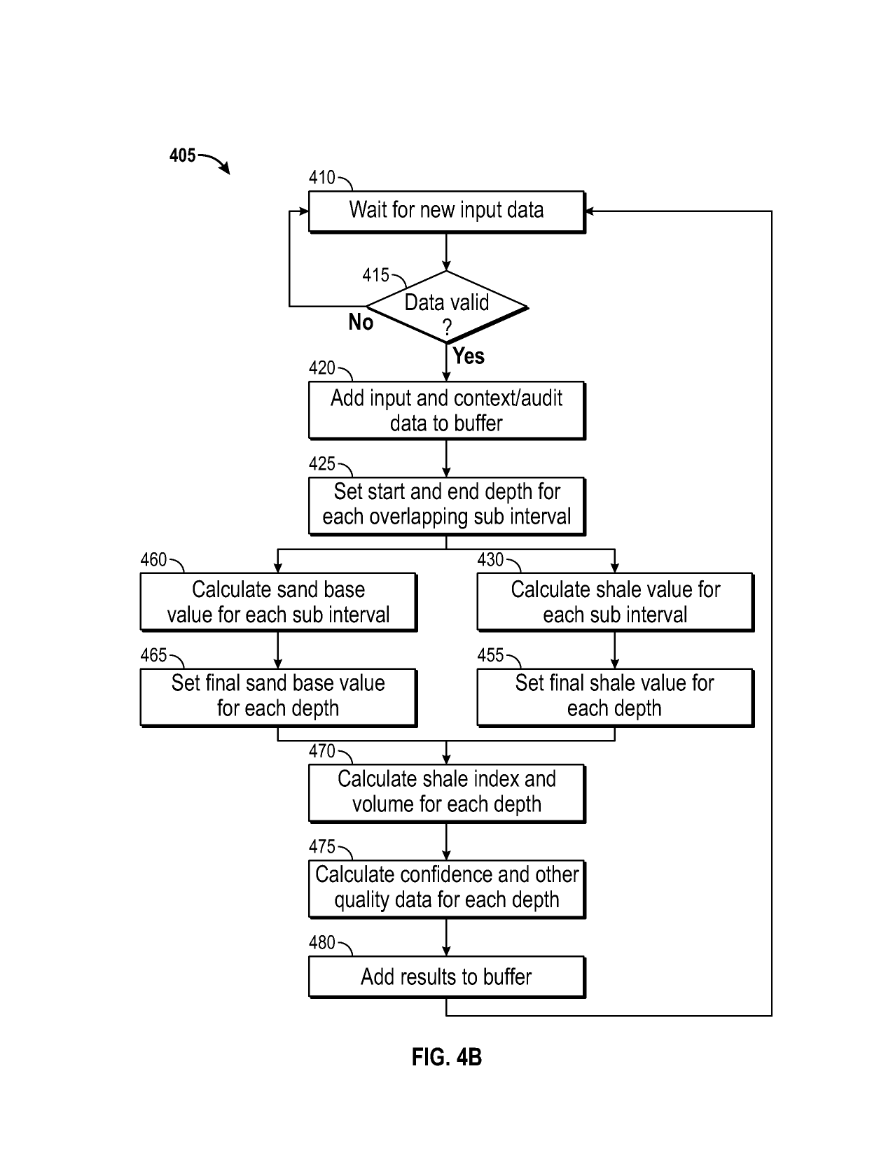

FIG. 4(a) shows a flow chart 400 elaborating on a non-limiting embodiment of step 330 in FIG. 3 for locating a shale layer. In step 410, logging data from the at least one sensor is received. In step 415, the logging data may be validated. The validation may be a simple check if the value fits into a pre-defined or automatically set value range but more complex processing steps can be included at this point. In step 420, the validated data may be written into a buffer. Context data may include all data other than the gamma rays found in the data set. The context data may be used to reproduce and archive calculations (e.g. applied environmental corrections). In step 425, start and end depths of each overlapping interval may be defined. In step 430, a shale cut-off value may be set for each sub interval. For each sub interval, the algorithm may calculate the shale cut-off value at a predefined or automatically set percentile of the gamma ray data. In step 435, a shale flag may be set based on a comparison of the new gamma ray data and the cut-off value for each sub interval. In step 440, a final shale flag may be set. In step 445, a confidence level for locating the shale layer may be estimated if the depth point is classified as shale. In some embodiments, step 445 may be optional. In some embodiments, step 445 may include other data quality metrics for each depth. In step 450, the results of steps 440 and optional step 445 may be written to a memory buffer. In some embodiments, steps 425 to 450 may include reprocessing and use of previous data and results.

FIG. 4(b) shows a flow chart 405 elaborating on another non-limiting embodiment of step 330 in FIG. 3 for estimating a shale index/volume). In step 410, logging data from the at least one sensor is received. In step 415, the logging data may be validated. The validation may be a simple check if the value fits into a pre-defined or automatically set value range but more complex processing steps can be included at this point. In step 420, the validated data may be written into a buffer. Context data may include all data other than the gamma rays found in the data set. The context data may be used to reproduce and archive calculations (e.g. applied environmental corrections). In step 425, start and end depths of each overlapping interval may be defined. In step 430, a shale cut-off value may be set for each sub interval. For each sub interval, the algorithm may calculate the shale cut-off value at a predefined or automatically set percentile of the gamma ray data. In step 455, a final shale value may be set for each depth. In step 460, a sand cut-off value may be set for each sub interval. For each sub interval, the algorithm may calculate the sand cut-off value at a predefined or automatically set percentile of the gamma ray data. In step 465, a final sand value may be set for each depth. In step 470, a shale index and volume may be calculated for each depth. The shale percentage may be a function of the shale index and volume. In step 475, a confidence level for the shale index/volume may be estimated is the depth point is classified as shale. In some embodiments, step 475 may be optional. In some embodiments, step 475 may include other data quality metrics for each depth. Step 475 is optional and may be distinct from or identical to step 340 depending on the application. In step 480, the results of step 470 (or step 475 if present) may be written to a memory buffer. In some embodiments, steps 425 to 475 may include reprocessing and use of previous data and results.

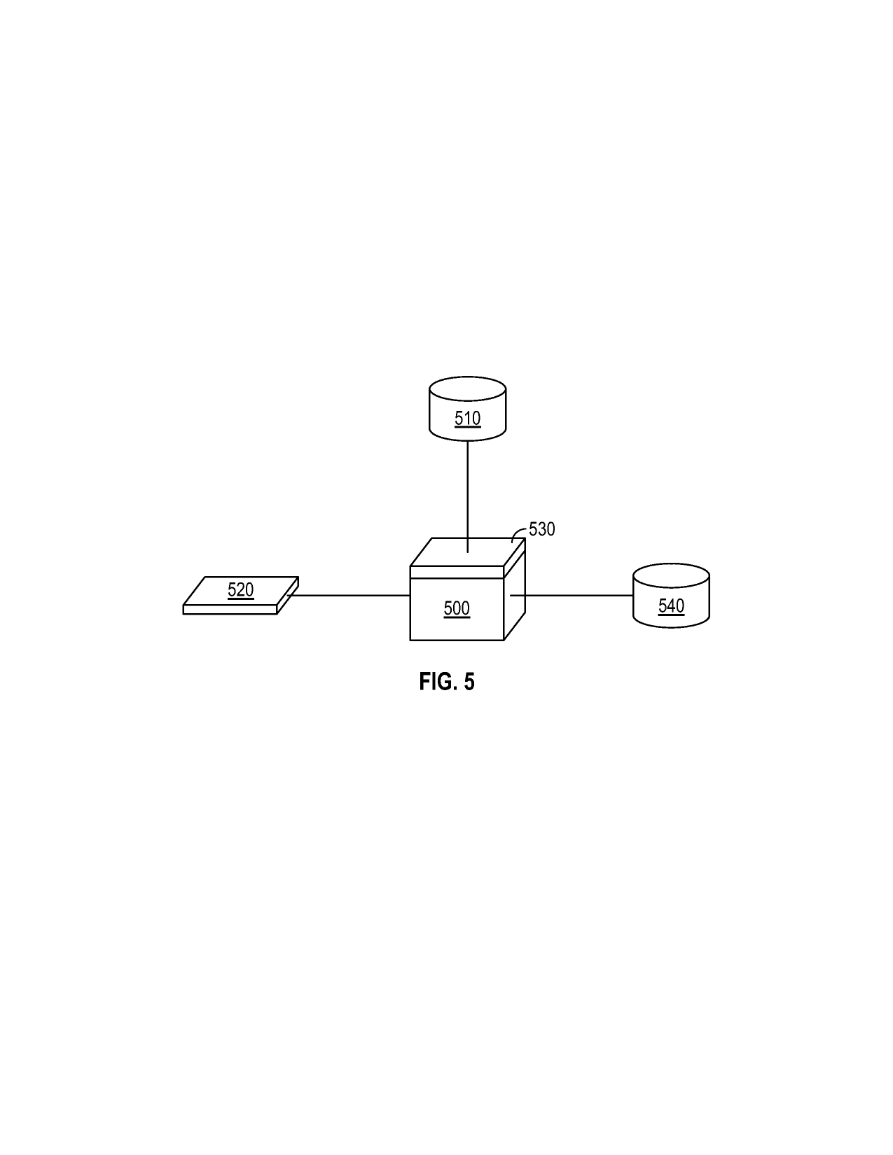

As shown in FIG. 5, certain embodiments of the present disclosure may be implemented with a hardware environment that includes an information processor 500, an information storage medium 510, an input device 520, processor memory 530, and may include peripheral information storage medium 540. The hardware environment may be in the well, at the rig, or at a remote location. Moreover, the several components of the hardware environment may be distributed among those locations. The input device 520 may be any information reader or user input device, such as data card reader, keyboard, USB port, etc. The information storage medium 510 stores information provided by the detectors. Information storage medium 510 may be any non-transitory computer information storage device, such as a ROM, USB drive, memory stick, hard disk, removable RAM, EPROMs, EAROMs, EEPROM, flash memories, and optical disks or other commonly used memory storage system known to one of ordinary skill in the art including Internet based storage. Information storage medium 510 stores a program that when executed causes information processor 500 to execute the disclosed method. Information storage medium 510 may also store the formation information provided by the user, or the formation information may be stored in a peripheral information storage medium 540, which may be any standard computer information storage device, such as a USB drive, memory stick, hard disk, removable RAM, or other commonly used memory storage system known to one of ordinary skill in the art including Internet based storage. Information processor 500 may be any form of computer or mathematical processing hardware, including Internet based hardware. When the program is loaded from information storage medium 510 into processor memory 530 (e.g. computer RAM), the program, when executed, causes information processor 500 to retrieve detector information from either information storage medium 510 or peripheral information storage medium 540 and process the information to estimate a parameter of interest. Information processor 500 may be located on the surface or downhole.

While the foregoing disclosure is directed to the one mode embodiments of the disclosure, various modifications will be apparent to those skilled in the art. It is intended that all variations be embraced by the foregoing disclosure.

What is claimed is:

1. A method of estimating at least one parameter of interest of an earth formation, comprising:
estimating the at least one parameter of interest using a statistical analysis of logging data acquired by at least one sensor, wherein the statistical analysis is applied over a plurality of overlapping intervals within the logging data.

2. The method of claim 1, further comprising:
acquiring the logging data using the at least one sensor.

3. The method of claim 2, further comprising:
conveying the at least one sensor in a borehole penetrating the earth formation.

4. The method of claim 1, wherein the at least one parameter of interest includes at least one of: (i) a location of a shale layer and (ii) a shale index/volume.

5. The method of claim 4, wherein the location of the shale layer estimation includes using a count of intervals in the plurality of intervals and a count of shale classifications in the plurality of intervals.

6. The method of claim 4, wherein the shale percentage estimation includes using an estimated sand line and an estimated shale line.

7. The method of claim 1, wherein the at least one parameter of interest is estimated in real time.

8. The method of claim 1, further comprising:
estimating a confidence level for the at least one estimated parameter of interest.

9. The method of claim 1, wherein the logging data comprises data from at least one of: (i) a gamma ray log and (ii) a spontaneous potential log.

10. The method of claim 1, wherein each of the plurality of overlapping intervals has an identical length.

11. The method of claim 1, wherein each of the overlapping intervals has a region that does not overlap with at least one other of the overlapping intervals.

12. An apparatus for estimating at least one parameter of interest in an earth formation, comprising:
a carrier configured to be conveyed in the borehole;
at least sensor disposed on the carrier and configured to acquire logging data; and
at least one processor configured to:
estimate at least one parameter of interest using a statistical analysis of the logging data acquired by the at least one sensor, wherein the statistical analysis is applied over a plurality of intervals within the logging data.

13. The apparatus of claim 12, wherein the at least one parameter of interest includes at least one of: (i) a location of a shale layer and (ii) a shale index/volume.

14. The apparatus of claim 12, wherein the at least one processor is configured to estimate the at least one parameter of interest in real time.

15. The apparatus of claim 12, the at least one process being further configured to:
estimate a confidence level for the at least one estimated parameter of interest.

16. The apparatus of claim 12, wherein the logging data comprises data from at least one of: (i) a gamma ray log and (ii) a spontaneous potential log.

17. The apparatus of claim 12, wherein each of the plurality of overlapping intervals has an identical length.

18. The apparatus of claim 12, wherein each of the overlapping intervals has a region that does not overlap with at least one other of the overlapping intervals.

19. A non-transitory computer-readable medium product having stored thereon instructions that, when executed by at least one processor, cause the at least one processor to perform a method, the method comprising:
estimating the at least one parameter of interest using a statistical analysis of logging data acquired by at least one sensor, wherein the statistical analysis is applied over interval plurality of intervals within the logging data.

20. The non-transitory computer-readable medium product of claim 19 further comprising at least one of: (i) a ROM, (ii) an EPROM, (iii) an EEPROM, (iv) a flash memory, and (v) an optical disk.
